(19) United States
(12) Patent Application Publication
(10) Pub. No.: US 2015/0131352 A1
(43) Pub. Date: May 14, 2015

(54) Multi-Level Converter Control

(71) Applicant: Control Techniques Limited, Newtown (GB)

(72) Inventors: Simon David HART, Welshpool (GB); Antony John WEBSTER, Montgomery (GB)

(21) Appl. No.: 14/537,471

(22) Filed: Nov. 10, 2014

(30) Foreign Application Priority Data
Nov. 12, 2013 (GB) 1319953.4

(51) Int. Cl. H02M 7/537

(52) U.S. Cl. CPC H02M 7/537
USPC 363/131

(57) ABSTRACT

A method is disclosed for controlling at least four switching components of a multi-level converter. The method comprises receiving first and second control signals for controlling a dual-level inverter having two switching components, and processing the first and second received control signals to produce at least four switching component control signals for controlling the switching components of a multi-level converter. Also disclosed are a control logic system, a multi-level converter system and a computer readable medium.

### CROSS-REFERENCE TO RELATED APPLICATION

This application claims the benefit and priority of Great Britain Patent Application No. 1319953.4 filed Nov. 12, 2013. The entire disclosure of the above application is incorporated herein by reference.

### FIELD

This disclosure relates to producing multi-level converter control signals. More specifically, but not exclusively, a method for converting control signals for a dual-level inverter such that they can be used with a multi-level converter is provided.

### BACKGROUND

Inverters are required in many electrical and electro-mechanical systems. For example, in high-power motor drive systems conversion of a DC source to an AC supply suitable for driving the motor is commonly required. In such systems, it is desirable to provide an AC signal that is as near to sinusoidal as possible in order to maximise the efficiency of the motor. One common way to improve the quality of such a DC-AC conversion process is the use of multi-level inverters or converters, which provide a switched stepping across the DC voltage range in order to more closely emulate a sinusoidal signal.

In addition to more closely resembling a sinusoidal waveform, multi-level converters offer various other advantages over simple dual-level inverters. For example, due to the output signal more closely resembling a sinusoidal waveform, harmonic distortion is decreased. Furthermore, since smaller voltage levels are used, a smaller change in voltage is seen, which in turn means that there is a reduced stress on motor bearings in a motor drive system. In addition, the clamping diodes limit the voltage across the OFF-state switching devices to one capacitor voltage level (half of the DC-link voltage). This reduces the voltage, so medium rated semiconductor devices can be used for high-voltage high-level applications.

While there are many advantages associated with use of multi-level converters there are also a number of disadvantages. In particular, due to the increase in the number of switching components required in multi-level converters the circuitry of such converters can be large and expensive. For example, control of multi-level converters requires many microprocessor pins per phase. Some methods use separate gate signals for each semiconductor switch and others use a pair of gate signals and additional signals to control the switch selection. However, in either arrangement the individual signals generally require level shifting and isolation. In practice, the circuitry required, particularly for high order multi-level converters, can therefore render such circuits impractical.

### SUMMARY

In accordance with an aspect of the invention there is provided a method for controlling at least four switching components of a multi-level converter. The method comprises receiving first and second control signals for controlling a dual-level inverter having two switching components. The method also comprises processing the first and second received control signals to produce at least four switching component control signals for controlling the switching components of a multi-level converter.

The method may further comprise controlling each of the at least four switching components using a respective control signal of the at least four produced control signals. The produced at least four control signals may comprise a control signal for each switching component of the multi-level converter.

A control signal derived from the first of the received control signals may be used to produce the switching component control signals. The control signal may determine which switching components will be activated in a next switching period. The derived control signal may be a combination of the first and second received control signals. The second of the received control signals may be inverted. The first and second received control signals may be combined by an AND logic gate. A number of pulses in the derived control signal when the second control signal is active may be used to determine which of the switching components will be activated in a next switching period. When the number of pulses in the derived control signal is 1 or more a first set of switching components may be activated. When the number of pulses in the derived control signal is 0 a second set of switching components may be activated. The derived control signal may be arranged to switch the switching elements associated with the highest voltage and the lowest voltage. The second received control signal may be arranged to switch the switching components within a middle range of an overall voltage range of the multi-level converter.

The method may further comprise deriving a routing signal from the two received control signals. The routing signal may be used to produce the switching component control signals by routing one of the second of the received control signals and the derived control signal to a respective switching component of the multi-level converter. The routing signal may be latched when the second of the received control signals is high. The routing signal may be reset by a rising edge of the derived control signal. The routing signal may be sampled on a falling edge of the second of the received control signals.

Dead-time may be provided between switching components that are actively being switched. The routing signal may maintain this dead-time when routing the control signals.

The first and second control signals may be produced by a microprocessor and received from the microprocessor via respective isolation circuitry and level shifters. The respective isolation circuitry and level shifters may be provided by respective optoisolators.

According to another aspect of the invention there is provided a control logic system for controlling at least four switching components of a multi-level converter. The control logic system comprises an input arranged to receive first and second control signals for controlling a dual-level inverter having two switching components. The control logic system also comprises a logic processor arranged to process the first and second received control signals to produce at least four switching component control signals for controlling the switching components of a multi-level converter.

According to yet another aspect of the invention there is provided a multi-level converter system, comprising a control logic system according as described herein. In addition the multi-level converter system comprises a multi-level converter having four or more switching components each being arranged to be switched by one of at least four switching component control signals produced by the control logic system.

According to a further aspect of the invention there is provided a computer readable medium comprising computer readable code operable, in use, to instruct a computer to perform any method as described herein.

The processor pin requirement for gate control of multi-level converters may be reduced.

The microprocessor may provide two augmented gate outputs per phase. An upper gate line may be prevented from gating the IGBT if the lower gate line is active. The upper gate line may be toggled to provide control selection pulses while the lower gate line is active to make the semiconductor switch selection for the next switching period.

The semiconductor switch selection control may be combined with two semiconductor switch gating signals to reduce the number of processor pins required. The gating signals may be per phase. This may reduce the amount of level shifting and isolation hardware required. The associated delays and batch or temperature tolerances may therefore also be reduced.

A number of control pulses sent on the upper signal line when the lower is active may control the “level pair” (S1 and S3 or S4 and S2) that will be switched during the next PWM period.

The upper signal from microprocessor may either switch the highest switching unit S1 or the lowest switching unit S4, i.e. the outer switches. The duty invert may be provided in software.

The lower signal from microprocessor may either switch switching units S2 or S3, the inner, 0V, switches. This may provide time for the control pulses to be sent out and provide the correct switch to switch dead time. Dead-time may be required between S2 and S4 when in the negative section and between S1 and S3 when in the positive section.

The change of voltage section may pass through a low voltage (so high 0V duty) switching period which corresponds to a long lower gate signal which permits time for the upper signal to send out the “level pair” control pulses.

Switching unit S3 may remain on during negative section and switching unit S2 may remain on during positive section.

The SW cycle period may begin at the centre of the lower ON period so that a decision regarding the selection of the “level pair” can be made and the control pulses sent out before the next activation of switching units S1 or S4, i.e. the outer switches.

The gate control hardware may interface directly with the fast over current protection line via an enable buffer.

Pulse drop/extension may be possible as both the lower and upper gate signals need to change state twice per cycle for any change in “level pair” to be actioned.

### DRAWINGS

Exemplary embodiments of the invention shall now be described with reference to the drawings in which:

FIG. 1 illustrates a multi-level converter along with its external control components;

FIG. 2 is schematic view of the circuit of the multi-level converter of FIG. 1;

FIG. 3 is a switching diagram showing the input control signals and the output transistor control signals;

FIG. 4 is a logic diagram illustrating the logic used to determine additional control signal and control line; and

FIG. 5 is a logic diagram showing how the transistor control signals are derived from the input control signals, additional control signal and control line.

Throughout the description and the drawings, like reference numerals refer to like parts.

### DETAILED DESCRIPTION

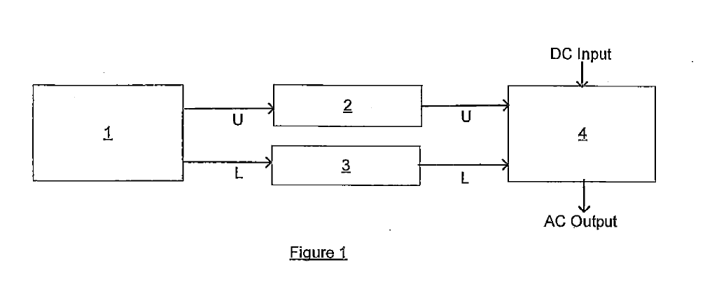

FIG. 1 shows a multi-level converter 4 along with the external control components 1, 2, and 3. Multi-level converter 4 receives a DC input and converts this into an AC output based on two transistor gate control signals U and L that are generated by an associated microprocessor 1. By use of multiple levels, the multi-level converter is able to provide an AC output that more closely resembles a sinusoid when compared to a single level inverter. The gate control signals U, L pass through respective conversion circuits 2, 3 for each of the three phases. This conversion circuitry includes level shifters in order to shift the level with respect to the respective emitter being controlled by the signal, in addition to isolation circuitry in order to isolate each transistor from the microprocessor. An optoisolator is used for both the isolation and the voltage level shifting.

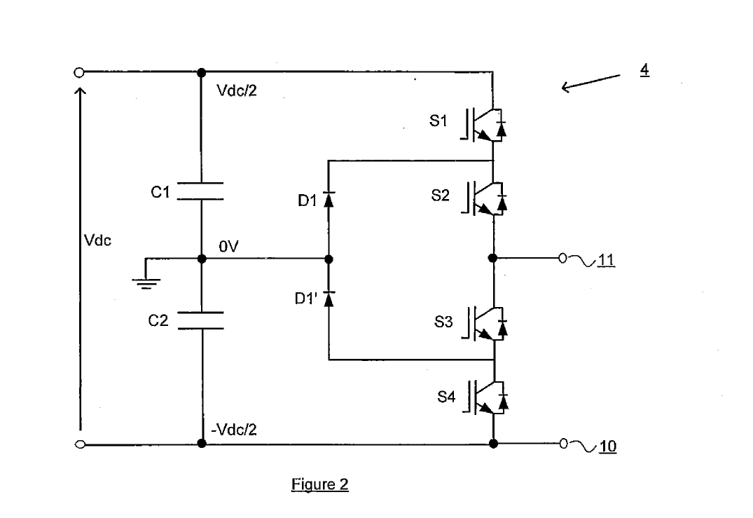

FIG. 2 is schematic view of the circuit of the multi-level converter 4 of FIG. 1. In FIG. 2 a three-level converter is depicted for simplicity of description. However, a greater number of levels may alternatively be used.

In FIG. 2, the input is provided by Vdc which is a DC source. An output is provided between a 0V pin 10 and output pin 11. First and second transistors S1 and S2 are provided in series between the positive terminal of the DC course Vdc and the output pin 11, with third and fourth transistors S3 and S4 provided in series between the output pin 11 and the 0V pin 10. Diodes D1 and D1′ are provided across the second and third transistors, with a ground connection provided between the two transistors. Furthermore, smoothing capacitors C1 and C2 are provided, each with one terminal connected to a respective terminal of the DC source Vdc and another terminal connected to ground. In FIG. 2, only a single phase of a three-phase system is shown for ease of explanation. It will be appreciated that the other phases use equivalent circuitry.

An AC output is provided by the output of the multi-level converter 4 by controlled switching of the four transistors S1, S2, S3, S4 in order to vary the output voltage from the DC input voltage. As is clear from FIG. 1, the multi-level converter 4 receives the two gate control signals U, L and uses logic to convert these two control signals into four control signals, one for each of the four transistors S1, S2, S3, S4.

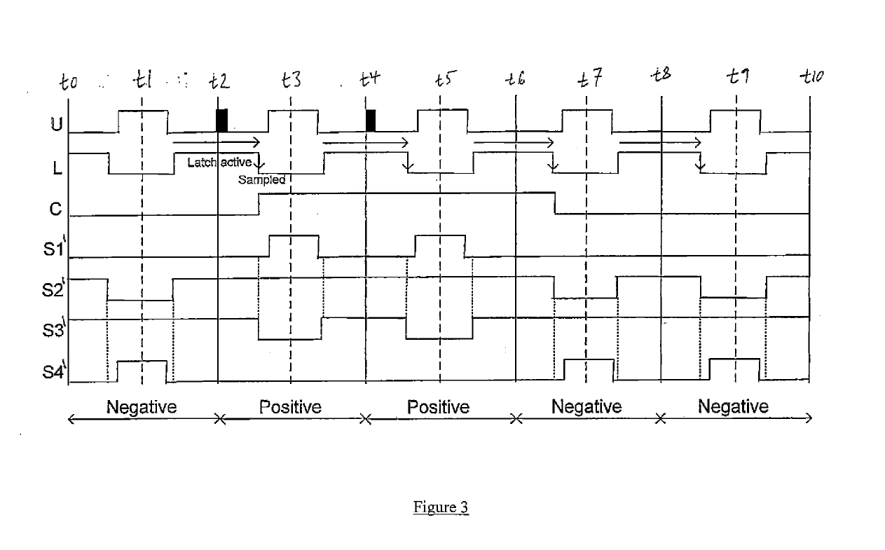

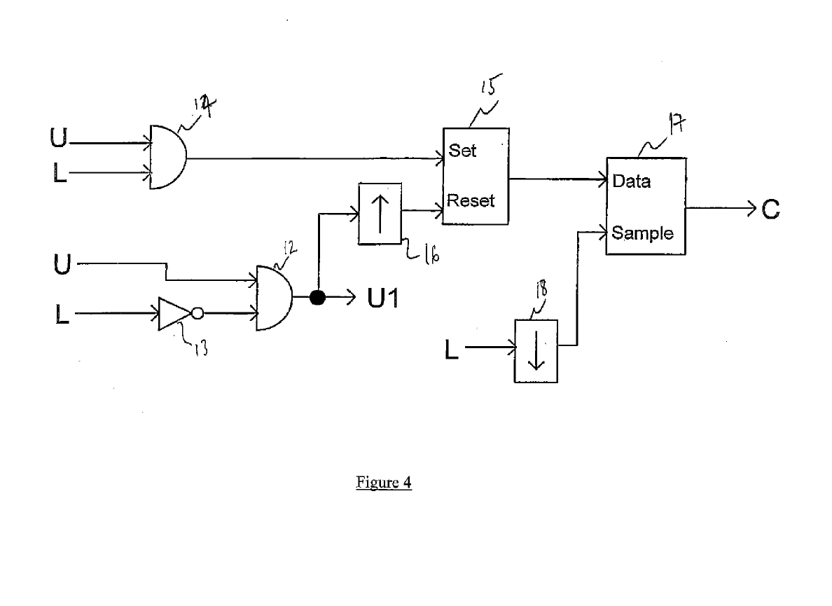

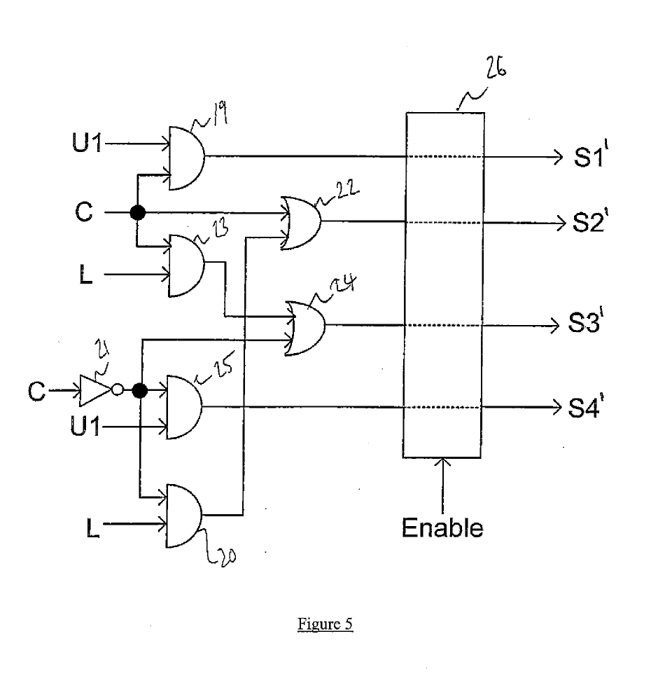

This control process shall now be described with reference to FIG. 3, which shows a switching diagram for deriving the transistor control signals S1′, S2′, S3′, S4′, along with FIGS. 4 and 5, which show the logic used for deriving the transistor control signals S1′, S2′, S3′, S4′ from the input gate control signals U, L.

Firstly, with reference to FIG. 4, additional gate control signal U1 and control line C are derived from the input gate control signals U, L. The two input gate control signals, the upper, U, and the lower L, are arranged for operating a standard dual level inverter having just two transistors. Hence, the first input gate control signal, U, is arranged to operate the upper transistor in such an arrangement, while the second input gate control signal L is arranged to operate the lower transistor.

The first additional control signal U1 is derived by passing gate control signal U and an inversion of gate control signal L through an AND gate 12, L being inverted by a NOT gate 13. In order to obtain the control line C, input gate control signals are firstly combined via an AND gate 14, the output of which is input to the ‘set’ input of a flip-flop latch 15. The additional gate control signal U1 is input to one of the four semiconductor switches as will be described in respect of the circuitry in FIG. 5, which will be described later in this document. The reset is only activated on the rising edge of U1 by use of rising edge detector 16 and then into the reset of the flip-flop latch. The output of the flip-flop 15 is input into the data input of the sampling buffer 17, while the gate control signal L that has passed through falling edge detector 18 is input into the sample input of the sampling buffer 17 which triggers a sample of the data input logic level. Then the output of the sampling buffer is the control line C, which can be seen in FIG. 3.

In practice, in the logic diagram shown in FIG. 4, the additional control signal, or actual upper gate signal, U1 is forced low whenever the second gate control signal L is active to prevent shoot through when the encoded control signal pulses are also being sent on the gate control signal U. The control signal pulse is latched when the second gate control signal L is high and is reset by the rising edge of the additional gate control signal U1. The control line C is sampled on the falling edge of the second gate control signal L so that the new routing of the gating signals U1 and L by the control pulses on control line C can come into effect before the next actual upper gate pulse U1. This produces the “level pair” control line C, which is the output by sampling buffer 17. Only one signal is provided for a 3 level system as the system only chooses between controlling two pairs of switches S1, S3 and S4, S2. For multi-level converters having five (and above) levels, the number of control pulses is counted, as discussed below.

In the case of a three-level converter there is only one control pulse on the control line C is required, if the control pulse is present, the more positive switches are used and if not the most negative switches are used. When using a system having 5 or more levels a series of pulses are provided to denote which pair of switches are being actively controlled by gate control signals U1 and L. These control signals would still pass through the flip-flop latch 15 shown in FIG. 4. In FIG. 4, a simple sampling buffer 17 is controlled by the falling edge of the gate control signal L. For 5 or more levels, a serial to parallel decoder is provided where the count is reset by the signal from the rising edge detector 16 and the sample buffer 17 has multiple inputs and multiple outputs.

Once the additional gate control signal U1, and control line C are derived by the logic circuit of FIG. 4, it is then possible to proceed with the derivation of the transistor control signals S1′, S2′, S3′, S4′ as shown in FIG. 5 and as will now be discussed.

S1′ is derived by combining the additional gate control signal U1 and control line C via an AND gate 19. S2′ is derived by combining, at an AND gate 20, input gate control signal L with an inversion of control line C, which is passed through a NOT gate 21, the output of the AND gate 20 being combined, at another OR gate 22 with the additional control line C. S3′ is derived by combining additional control signal C with control signal L at an AND gate 23, and then passing the output of this AND gate 23 through an OR gate 24 with an inversion of the control line C, which has passed through NOT gate 21. S4′ is derived by combining, at an AND gate 25, the additional control signal U1, with the inversion of control line C, which is inverted by NOT gate 21. Each of the signals S1′, S2′, S3′, S4′, pass through a gate or enable buffer 26. The enable buffer 26 allows for the system to be deactivated in case of over-current conditions. The enable buffer 26 is controlled by an enable signal for enabling and preventing operation of the multi-level converter 4.

In practice, the level pair control line C provides a routing signal that controls to which outer switch (S1 or S4) the actual upper gate signal U1 will be connected. It also controls which inner switch (S2 or S3) the lower gate signal will be connected to. The control line C also holds the inner switch not currently being controlled by the lower gate signal high, active. The outer switch not currently being controlled is held low, inactive. In other words control line C routes the received control signals to the switching components.

In FIG. 3, switching of the multi-level converter 3 is shown wherein the output voltage demand changes from negative to positive and then back to negative as represented by control line C and the “level pairs” being switched in a PWM fashion, i.e. the pair of switching components S1, S3 for positive voltage or S4, S2 for negative voltage. The “level pair” chosen, and hence the signal routing, is controlled by the control pulses sent on the upper gate control line U when the lower gate control line L is active. For example, times t2 and t4 show one pulse (a choice between only two pairs has to be made for a 3 level converter) to select the pair of switches that produce the more positive voltage (S1, S3). The number of control pulses sent on the upper signal line U when the lower L is active (the lower takes president) controls the “level pair” that will be switching the next PWM period. One control pulse denotes that the next PWM cycle will be on the positive “level pair” (so there will be positive voltage.) An absence of control pulse denotes the negative “level pair”. In other words no pulse (for a three level converter) means that the system selects the pair of switches that produce the more negative voltage (e.g. S4, S2). Notice that the first switching component in the pairs is the one connected to the gate control signal U1 and the second is the one connected to the control signal L. Only one control pulse is required to denote the positive pair of switches. An absence of control pulse selects the negative pair of switches.

In FIG. 3, the pulse width modulation (PWM) period, also known as the switching period, lasts from t1 to t3 and repeats. A change to the timing of the switching level is updated at the start of the switching period (t1, t3 etc) so all decoding and routing must be ready for implementation at the start of the next switching period. The software in the microprocessor runs at the middle t2 of each switching period. The gate control signal U controls the two outer switches S1 or S4. The longer that the gate control signal U is on, the greater the resulting average voltage will be (either positive or negative). The gate control signal L controls the inner switches S2 or S3 when they are not being held closed to enable current to flow through S1 or S4. The longer the gate control signal L is on for the lower the voltage will be towards zero. The lower signal takes priority over the gate control signal U, so if the gate control signal L is active, the gate control signal U is held low internally and so S1 and S3 will not short circuit the capacitors and cause damage to the circuit. The signal that is routed to S1 or S4 is called the gate control signal U1 and is the state of control signal U if gate control signal L is low, else gate control signal U1 is held low. The control line C controls the routing of gate control signals U1 and L. A high control line C routes gate control signal U1 to S1, closes S2 so that current can flow through S1 and routes gate control signal L to S3. A low control line C routes control signal U1 to S4, closes S3 so that current can flow through S4 and routes control signal L to S2. The PWM ratio action is provided by the alternating switch action of S1 and S3 when providing positive voltage, and S4 and S2 when providing negative voltage. The routing of the gate control signals U1 and L signals means that there is a dead-time provided between the actively switching devices, S1 and S3 or S4 and S2. If the gate control signal U becomes high while the gate control signal L is on it is passed to a latch. The latched signal is sampled as the gate control signal L changes from the high to low state and becomes the routing control line signal C. The gate control signal U becomes high shortly after t2 after the software has run and decided what switch routing is required for the next switching period. FIG. 3 shows a duty cycle, control pattern and switching states that provide a negative voltage, then a positive voltage and then returning to a negative voltage. The high gate control signal U at t2 changes the routing from negative (i.e., S4 and S2) to positive (i.e. S1 and S3) at the start of the next switching period, t3. The high gate control signal U at t4 keeps the routing to the positive (i.e. S1 and S3) through the next switching period (starting at t5). The absence of gate control signal U being high after t6 changes the routing from positive (i.e. S1 and S3) to negative (i.e. S4 and S2) at the start of the next switching period, t7.

In the system described above there is the possibility of shoot through occurring, i.e. two supply lines being connected due to switches being on at the same time. The potential overlap due to delays in the gate circuits is removed by inserting a dead period, known as the dead-time, between switches. In a multilevel converter this only needs to be provided between the switches in each pair (i.e. S1, S3 and S4, S2). The two dual level gate control signals U and L already have the dead-time included between their U and L signals. The system described herein routes these signals to make sure that that dead-time is used correctly for the multiple level converter.

The control signal for systems with >=5 levels is encoded onto the gate control signal U while the gate control signal L is actively turning a switch on. When doing this it is important to make sure that there is enough time for the pulses to be sent out so the gate control signal L needs to be on for at least the time required to send the signals out. The arrangement of the routing in the system described herein means that the mid voltage point (0 on FIG. 2) is used to send the control information as this voltage is always passed when moving from positive to negative voltage and vice versa. The system ensures that the lower ON time is long enough to get the control routing data out.

Switching element S3 will remain on during negative section and switching element S2 will remain on during positive section so that current can flow from the outer switches S1 and S4 to/from the output 11. For example, when switching element S1 is closed and the current needs to flow into the output node 11, switching element S2 needs to be on as there is no other path. D1 and the anti-parallel diode in S2 are reversed biased.

The software cycle period begins at the centre of the lower ON period so that a decision regarding the selection of the “level pair” can be made and the control pulses sent out before the next activation of the outer switches, S1 or S4. This is part of the decision to make the lower switches take priority. It is safer to extend the time spent at zero voltage to get information across than at higher voltage. The zero output voltage requires a 50% duty of gate control signals L to U so there is plenty of time for the control pulses to be sent.

There is the risk of a conduction from one output phase to another without adequate impedance, from an output to earth, or from the output to 0V or either +Vdc/2 or −Vdc/2. In such circumstances a short circuit fault will occur and the semiconductor switches can be damaged before any software protection solution is able to turn them off. In this situation a fast hardware turn-off (<0.5 μs) is provided. The gate control hardware interfaces directly with a fast over current protection line via the enable buffer 26 in FIG. 5.

Pulse drop/extension is possible as both the lower and upper gate signals need to change state twice per cycle for any change in “level pair” to be actioned. When either the maximum positive or negative voltage is required the highest duty (i.e. the maximum on time) of either switching element S1 (for positive) or switching element S4 (for negative) is required. Inverter PWM generation is unusually based around a microprocessor counter that needs to supply two changes of state per PWM period (known as the switching period), so even if switching element S1 is intended to stay on for the whole PWM period, a short period (equal to the deadtime) of switching element S3 has to be provided as well. A second concern is that semiconductor switches have a loss associated with changing state, known as switching loss. In an ideal world switching element S1 is left on for the whole PWM period. As such, the switching loss is removed and 100% duty factor is achieved. This is done by pulse dropping and pulse extension. The short switching pulse S3′ is dropped and the pulse S1′ is on for all the PWM period. The system encodes information at specific points in the PWM timing diagram, for example t2 in FIG. 3. the system is designed to work even if a high gate control signal L is not sent out, e.g. if the pulse S3′ is dropped. In this case, a new control routing selection is not sampled so switching element S1 just stays on, which is what is wanted as it is a pulse extension. Only the time for S1 (if positive) or S4 (if negative) needs to be extended, which is another reason why the gate control signal U1 is routed to switching element S1 or S4, so they can be extended, while the gate control signal L is routed to switching element S2 or S3, which can be dropped without unintentionally changing the control routing.

In an alternative arrangement the upper and lower switching procedure described with respect to FIG. 3 is reversed. In FIG. 3, the timing diagram would move by half a PWM period and the gate control signal U would take precedence over the gate control signal L (in FIG. 3 described above, the gate control signal L takes precedence). As such, a gate signal L1 is derived using the logic rather than gate signal U1.

It will be appreciated that the logic functionality shown in FIGS. 4 and 5 may be implemented in alternative ways and achieve the same functional effect.

When components are referred to as upper and lower it will be appreciated that these terms could be replaced with first and second respectively. In particular, the components referred to as being upper or lower have no advantage from being above or below one another, but this terminology is used simply to tie the descriptive language in with the representation of the circuits in the Figures.

The various methods described above may be implemented by a computer program. The computer program may include computer code arranged to instruct a computer to perform the functions of one or more of the various methods described above. The computer program and/or the code for performing such methods may be provided to an apparatus, such as a computer, on a computer readable medium or computer program product. The computer readable medium could be, for example, an electronic, magnetic, optical, electromagnetic, infrared, or semiconductor system, or a propagation medium for data transmission, for example for downloading the code over the Internet. Alternatively, the computer readable medium could take the form of a physical computer readable medium such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

An apparatus such as a computer may be configured in accordance with such code to perform one or more processes in accordance with the various methods discussed herein. Such an apparatus may take the form of a data processing system. Such a data processing system may be a distributed system. For example, such a data processing system may be distributed across a network.

1. A method for controlling at least four switching components of a multi-level converter, the method comprising:
receiving first and second control signals for controlling a dual-level inverter having two switching components; and
processing the first and second received control signals to produce at least four switching component control signals for controlling the switching components of a multi-level converter.

2. The method according to claim 1, further comprising controlling each of the at least four switching components using a respective control signal of the at least four produced control signals.

3. The method according to claim 1, wherein the produced at least four control signals comprise a control signal for each switching component of the multi-level converter.

4. The method according to claim 1, wherein a control signal derived from the first of the received control signals is used to produce the switching component control signals.

5. The method according to claim 4, wherein the derived control signal is a combination of the first and second received control signals, wherein the second of the received control signals is inverted.

6. The method according to claim 5, wherein the first and second received control signals are combined by an AND logic gate.

7. The method according to claim 4, wherein a number of pulses in the derived control signal when the second control signal is active is used to determine which of the switching components will be activated in a next switching period.

8. The method according to claim 7, wherein when the number of pulses in the derived control signal is 1 or more a first set of switching components is activated, and when the number of pulses in the derived control signal is 0 a second set of switching components is activated.

9. The method according to claim 4, wherein the derived control signal is arranged to switch the switching elements associated with the highest voltage and the lowest voltage.

10. The method according to claim 4, wherein the second received control signal is arranged to switch the switching components within a middle range of an overall voltage range of the multi-level converter.

11. The method according to claim 4, further comprising deriving a routing signal from the two received control signals, wherein the routing signal is used to produce the switching component control signals by routing one of the second of the received control signals and the derived control signal to a respective switching component of the multi-level converter.

12. The method according to claim 11, wherein the routing signal is latched when the second of the received control signals is high, the routing signal is reset by a rising edge of the derived control signal, and the routing signal is sampled on a falling edge of the second of the received control signals.

13. The method according to claim 11, wherein dead-time is provided between switching components that are actively being switched and the routing signal maintains this dead-time when routing the control signals.

14. The method according to claim 1, wherein the first and second control signals are produced by a microprocessor and received from the microprocessor via respective isolation circuitry and level shifters.

15. The method according to claim 14, wherein the respective isolation circuitry and level shifters are provided by respective optoisolators.

16. A control logic system for controlling at least four switching components of a multi-level converter, the control logic system comprising:
an input arranged to receive first and second control signals for controlling a dual-level inverter having two switching components; and
a logic processor arranged to process the first and second received control signals to produce at least four switching component control signals for controlling the switching components of a multi-level converter.

17. A multi-level converter system, comprising:
a control logic system according to claim 16; and
a multi-level converter having four or more switching components each being arranged to be switched by one of at least four switching component control signals produced by the control logic system.

18. A non-transitory computer readable medium comprising computer readable code operable, in use, to instruct a computer to perform the method of claim 1.
